(19) United States
(12) Patent Application Publication
(10) Pub. No.: US 2012/0032816 A1
(43) Pub. Date: Feb. 9, 2012

(54) System And Method For Controlling Sport Event Transducers

(76) Inventors: Jeffrey C. Cho, Northborough, MA (US); Bruce J. Barker, Franklin, MA (US)

(21) Appl. No.: 12/944,149

(22) Filed: Nov. 11, 2010

Related U.S. Application Data
(63) Continuation-in-part of application No. 12/896,989, filed on Oct. 4, 2010.
Application No. 12/896,989 is a continuation-in-part of application No. 12/852,361, filed on Aug. 6, 2010, now abandoned.

(51) Int. Cl. G08B 5/00

(52) U.S. Cl. 340/815.4

(57) ABSTRACT

A system and method for controlling a plurality of sport event transducers, each of which includes an output element that can emit a perceivable output in response to an event that relates to a sport team, such as for example by emitting an audio-visual output when a particular football team scores a touchdown. The system remotely controls such transducers in response to sport team events by broadcasting an RF signal carrying team event messages, such as for example by transmitting an FM radio-data broadcast that carries a team event message embedded in the FM signal as RDS data. The sport event transducer receives and decodes such RF broadcast signals. If the transducer receives a team event message that relates to the transducer's affiliated team, the transducer's output element emits an audio and/or visual output signal in response to the message.

This is a continuation-in-part of application Ser. No. 12/896,989 filed on Oct. 4, 2010 entitled “Sport Event Transducer,” and a continuation-in-part of application Ser. No. 12/852,361 filed on Aug. 6, 2010.

### FIELD OF THE INVENTION

The present invention relates generally to sport team merchandise and in particular to sport garments such as caps and jerseys that bear team logos or other graphic images relating to a sport team, such as popular national sports teams as well as local or regional sports teams and the like. Such merchandise is typically worn or carried by fans to show their loyalty to and interest in a particular team or player.

### BACKGROUND OF THE INVENTION

Many sports fans wear caps or other items that bear the logos or other indicia of a team or player they support. When attending games, some fans carry posters, signs or flags bearing pictures or text for display to others in the audience or to television cameras that broadcast the event. A team logo or other indicia is often printed on these items. However, U.S. Pat. No. 6,511,198 describes a jersey having a fabric made of light emitting polymers for electronically displaying a team logo or other sports related message. The message can be modified to remain up to date. For example, the patent says that the “user may alter the display to read ‘New York Yankees—World Champions 1999.’

### SUMMARY OF THE INVENTION

The invention relates generally to a system and method for controlling a plurality of sport event transducers, such as those described in co-pending application Ser. No. 12/890,989 filed on Oct. 4, 2010, which is incorporated herein by reference. The scope of invention, and its various aspects, is provided in the claims below. However, for purposes of illustration, in an example of one aspect of the invention, a system controls a plurality of football-team jerseys, each of which has a display element that emits a light and/or sound output. The system determines when a particular football team has scored a touchdown and then transmits an encoded message to those jerseys, causing them to emit a corresponding audio-visual output in celebration of the touchdown.

### BRIEF DESCRIPTION OF THE DRAWINGS

FIGS. 1(a) and 1(b) illustrate a sport event transducer in the form of a cap having output elements and an intelligent controller with an FM radio receiver.

FIG. 2 is a diagram of a transmission system for preparing and transmitting RDS team event messages.

FIGS. 3a and 3b are diagrams of the structure of an RDS data group specified in the RBDS standard.

FIG. 4 is a diagram of a type “3A” group that is encoded to notifying Sport Event Transducers of a selected group type for use in carrying team event messages.

FIG. 5 is a diagram of an RDS data group of type 11A that is encoded with a team event message.

FIG. 6 is a diagram of a transmission system that includes a plurality of FM stations under the control of a central server.

FIG. 7 is a flow chart of the general operation of a central server of FIG. 6.

FIG. 8 is flow chart of the general operation of a station server of FIG. 6.

FIG. 9 is a diagram of a transmission system that includes a plurality of FM stations, cable TV networks, and “hot spots,” under the control of a central server.

### DETAILED DESCRIPTION OF AN EMBODIMENT

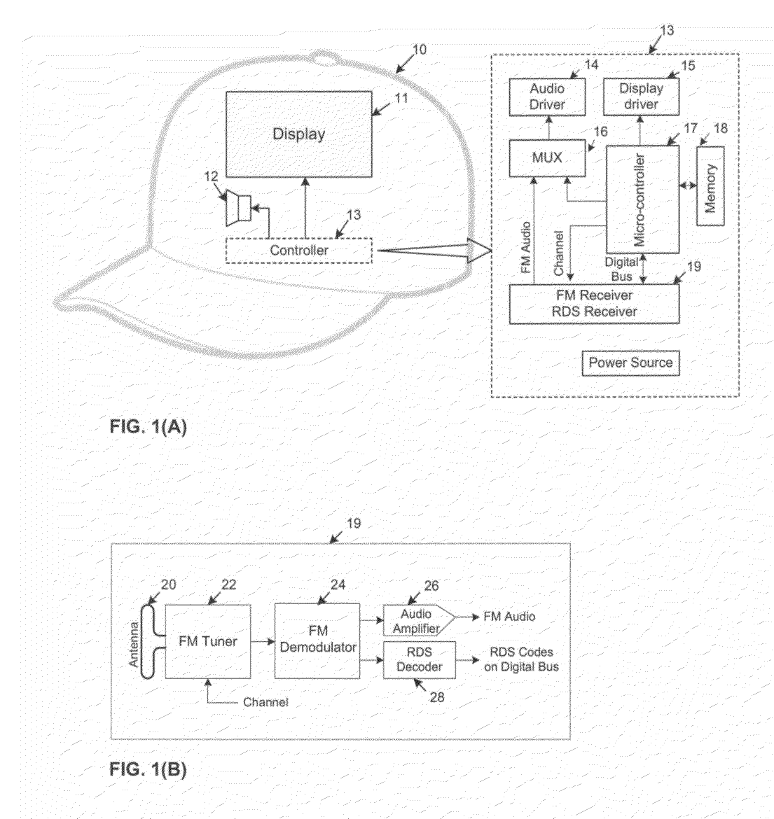

FIGS. 1(a) and 1(b) depict an example of a Sport Event Transducer in the form of a garment 10 that includes one or more display elements 11 and one or more speaker elements 12, as well as a controller 13 for controlling the output of these elements. Garment 10 will typically bear a logo or other marking or indicia of a sport team or player (herein “team”). Regardless of whether the garment bears such markings of a particular team, the garment includes a team identifier for electronically identifying a sport team associated with the garment. Any type of team identifier can be used, as long as it can specify the garment's team affiliation to the controller.

A display element can be a single light emitting diode (“LED”) or multiple LEDs. Alternatively, it can be implemented using any material that glows or emits light under electronic control. The speaker element 12 can be any known acoustic transducer for emitting a sound signal in response to a signal, such as known piezoelectric transducers or electromagnetic speakers.

The controller 13 also includes a receiver 19 for receiving a broadcast FM signal that contains commands for controlling the display element 11 and/or speaker element 12. For example, in one application of the invention, a plurality of garments each bear the logo for a popular NFL team, herein “Team A.” When Team A scores a touchdown during a game, a broadcast transmission system broadcasts an FM radio-data signal that contains an embedded team event message that notifies all Team A garments within the vicinity that a touchdown has occurred. Each of the garments that receive the transmission extract the team event message from the radio broadcast. For those garments affiliated with Team A, the garments' controllers cause the garments' display elements and/or their speaker elements to emit a corresponding output in celebration of the touchdown.

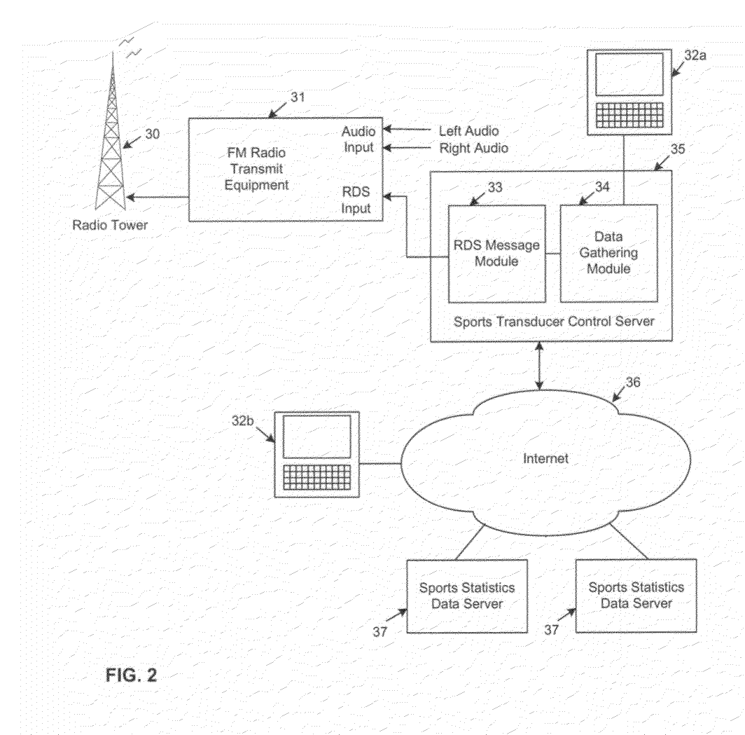

Referring to FIG. 2, a sport event transducer (“SET”) controller system transmits team event messages over a wide area (such as an area that encompasses the geographic market for a popular sport team) using a signal format that can penetrate homes and other buildings with sufficient strength to permit them to be decoded by Sport Event Transducers within those structures. In the example shown, the system includes an FM radio station antenna 30 that is coupled to the transmitter of conventional FM station radio-data equipment 31 that complies with the Radio Broadcast Data System (“RBDS”). The National Radio Systems Committee (“NRSC”) has defined a standard for RBDS that specifies how to embed data in FM radio transmissions to thereby communicate the data (herein “RDS data”) using the same radio signals that carry music or other sound content.

Those skilled in the art know that the standard for RBDS specifies in detail the format for RDS data, and that it shows a general technique for encoding and modulating an FM signal so that the signal carries a pair of audio signals as well as an RDS data stream. Any technique and corresponding circuitry/software can be used to prepare such FM radio-data signals that are compatible with the receivers 19 of Sport Event Transducers.

The system of FIG. 2 includes an SET control server 35 for supplying RDS data to the FM station system 31. As explained in greater detail below, the server 35 prepares the RDS data for transmission by the radio station equipment 31 and its antenna 30.

The SET control server 35 includes a data-gathering module 34 for obtaining real-time information concerning the status of certain sporting events. For example, in one embodiment, the module includes a user console 32(a) for accepting user input of sports information. In this example, a user observes a sporting event (live or remotely) and enters selected status information into the console as events occur, such as when a football team scores a touchdown. As explained below, this information can be used to trigger the broadcast of a corresponding team event message. Furthermore, the user of console 32(a) can also issue a team event message that is independent of any particular scoring event. For example, the user can issue a team event message directing all team garments and other sports transducers to light up or issue a sound blast at any moment that the user deems appropriate, such as at a moment during a game that the user considers critical or exciting.

In another embodiment, the system includes a remote user console 32(b) that operates in essentially the same way as local console 32(a), except that it supplies its input to the data-gathering module 34 from a remote location. In such embodiments, the transmissions between the remote console and data gathering module are secured to prevent unauthorized persons from triggering team event messages, for example using known cryptographic techniques to identify authorized users, or by otherwise encrypting communications between the remote console and the control server.

In other embodiments, the module 34 automatically gathers sporting information from one or more remote servers, for example via the Internet. In the example shown, there are several sports statistics servers 37 accessible via the Internet that provide real-time sports information, such as current scores of baseball games and other real-time game statistics. The gathering module receives such information from one or more such servers, and supplies it to a messaging module 33.

The messaging module 33 detects from this input the occurrence of certain predefined events and, in response, instructs the system 31 to broadcast a corresponding team event message to Sport Event Transducers of a specified type, thereby simultaneously notifying a plurality of Sport Event Transducers of the event in real-time. Returning to the example above, if Team A scores a touchdown, the data-gathering module 34 quickly learns of that event and promptly notifies the messaging module 33. In response, the messaging module prepares a corresponding team event message and forwards the message to the FM radio system 31 for transmission in a format that is compliant with RBDS.

The RBDS standard allows FM radio stations to transmit data on an FM channel by encoding the data into a subcarrier signal that is injected into an FM audio signal to thereby form a composite FM signal. The standard specifies how to encode several pre-defined types of data into the composite signal. For example, it defines how to encode data that tunes radio receivers, and data called “radio text” that is displayed by the receiver, such as the name of a song currently playing on the FM channel.

The RDBS standard also describes a protocol for encoding data for undefined applications called “Open Data Applications.” The standard allows for over 65,000 open data applications, each of which can be assigned a unique sixteen-bit identification code called the “Application Identifier” or “AID.” Such AID numbers are assigned by an RDS Registration Office in response to requests from those wishing to transmit data for an application that is not pre-defined in the RBDS standard.

In one embodiment of the present invention, a user obtains from an RDS Registration Office, an AID code for the sports event transducer application. This AID code is then used to identify team event messages broadcast in accordance with the RDS system as explained below.

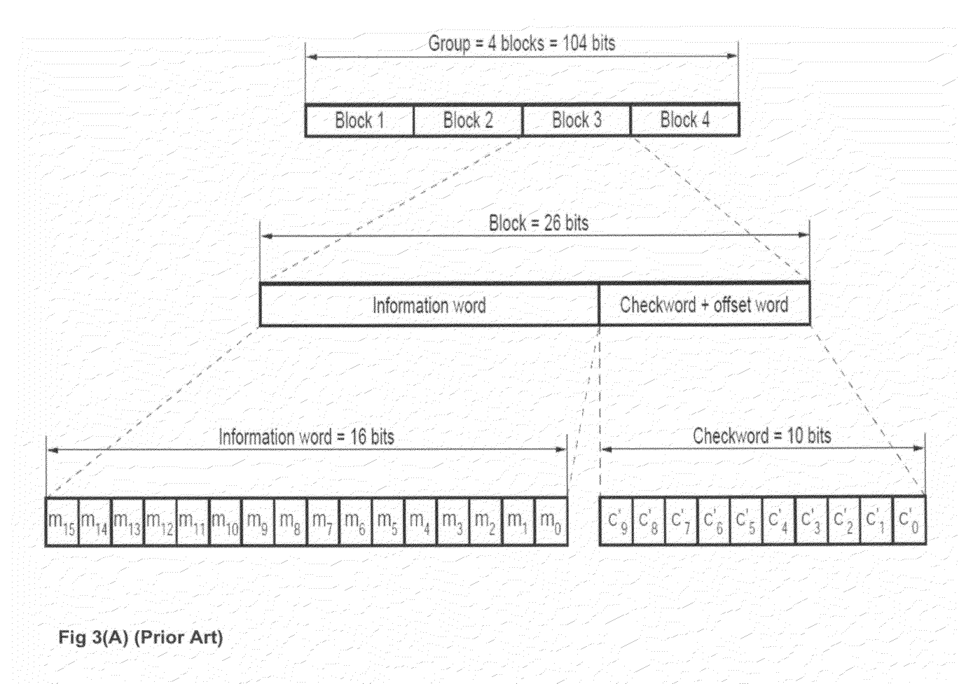

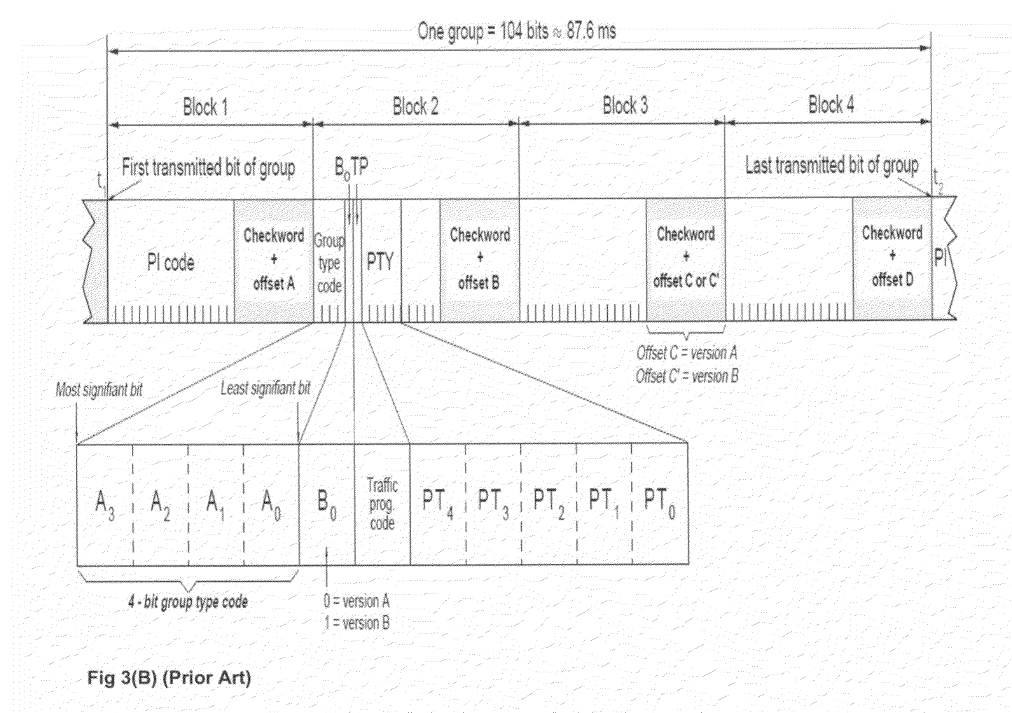

RDS data is formatted in “groups” of 104 bits that are arranged in four “blocks” of twenty-six bits each, as shown in FIGS. 3a and 3b (reproduced from the industry standard). The second block of each group includes a five-bit “group type” code that specifies the group's purpose, as shown in table 3 of the RBDS specification. For example, the group type “0A” is used to transmit data for tuning FM receivers, while group type “2A” is used for transmitting radio text. The RBDS specification allocates only nineteen group types for use by Open Data Applications (“ODAs”). Since there are far more than nineteen possible ODAs, the ODAs must share the nineteen ODA group types.

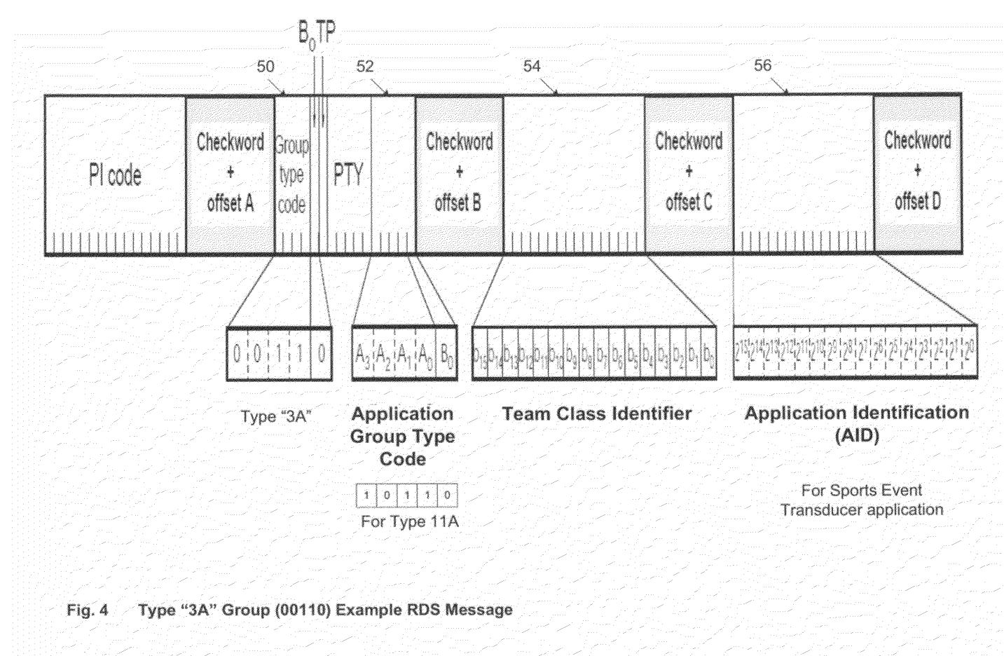

The messaging module 33 uses ODA group types for carrying team event messages as follows. First, the messaging module 33 (and/or the transmission system 31) selects one of the available ODA group types. It then notifies all sports event transducers in the area of the selection by broadcasting a type “3A” group as shown in FIG. 4.

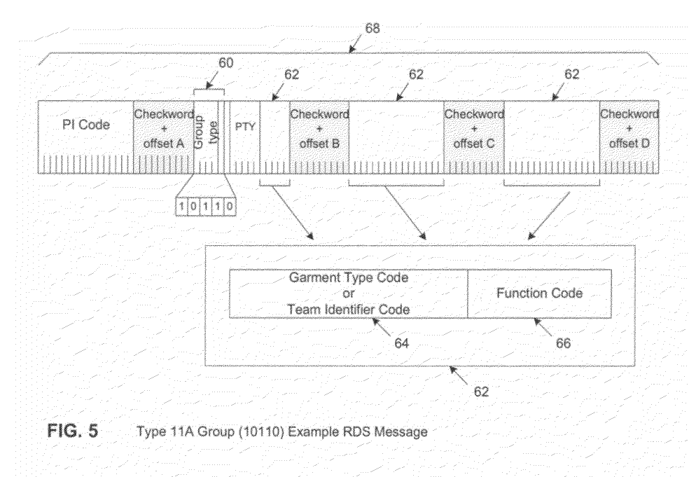

Field 56 of the type 3A group contains the AID that is registered for the Sport Event Transducer Application, thereby indicating to all receivers that this type 3A group is for the Sport Event Transducer Application. Field 52 provides an Application Group Type Code that identifies the ODA group type that was selected for the Sport Event Transducer Application. In this example, the Application Group Type Code equals 10110, thereby indicating that group type 11A was chosen. Thus, the type 3A group shown in FIG. 5 notifies all receivers that ODA group type 11A will carry data for the Sport Event Transducer Application.

The type 3A group also includes a field 54 that can carry other information for sports event transducers. For example, in the embodiment shown, the field 54 contains a team class identifier that identifies a team or a group of teams to whom this type 3A group is directed. For example, if a given radio station is using type 11A groups to carry team event messages for all of the major teams in the area around Boston, Mass., then field 54 contains a team class identifier indicating this fact. Alternatively, if the radio station uses group type 11A only to carry messages for one team (such as the New England Patriots), then the patriots' team identifier would be placed in field 54. In this manner, a radio station can assign one or more teams to a selected ODA group.

Once the selected group type 11A has been broadcast to the sports event transducers in the region, message module 33 and transmitter 31 begin transmitting type 11A groups filled with team event messages. FIG. 5 depicts the format of a type 11A group that is encoded with a team event message.

Referring to FIG. 5, field 60 of the group contains the code for type 11A, i.e., 10110, and field 62 carries the team event message. In this example, the message is thirty-seven bits long because type 11A groups have a thirty-seven-bit payload. However, type B groups can also be used to carry messages, in which case the team event message would have only twenty-one bits.

The team event message 62 includes a team identifier code 64 (or “garment type code” for garment-type transducers) that identifies a particular team to which the message is directed, such as Team A in the above examples. The message also includes a function code 66 that specifies the type of event that has occurred (or a particular function to be performed), such as for example a code that indicates that a touchdown has occurred. As explained below, sports event transducers receive and decode such team event messages and perform a corresponding function or action.

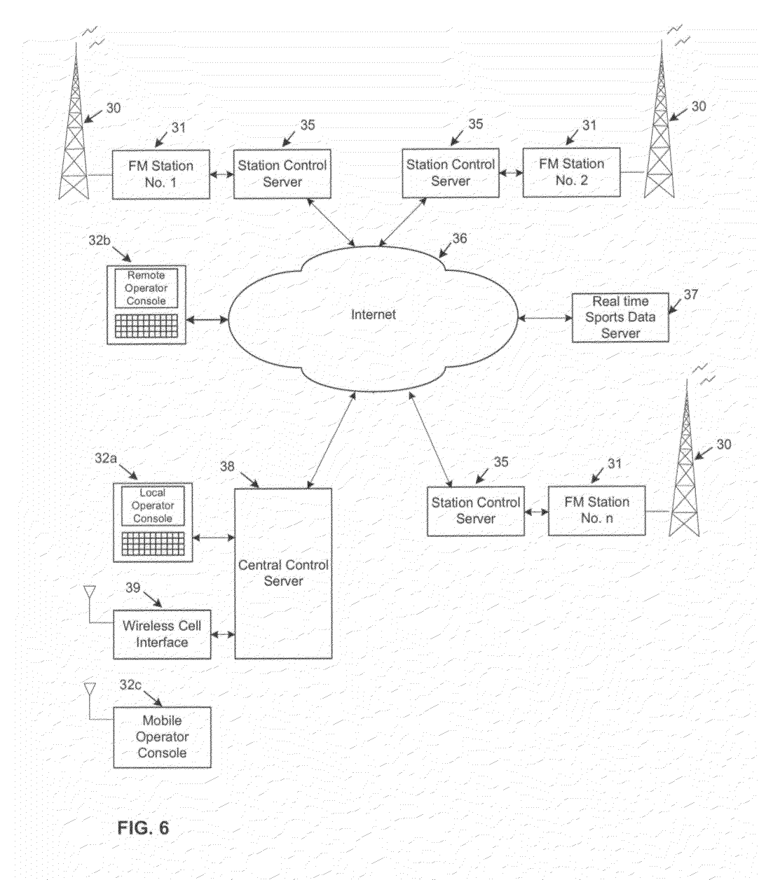

A sport event transducer control system can include multiple radio stations 31 that collectively reach a much larger geographic region than any single station. FIG. 6, for example, depicts a system having a large number of radio stations (“FM₁-FMₙ”) that are located in different sites. For example, they can all be located within a market for a particular sports team, such as the New England region, or they can span the entire country. In some embodiments, the radio stations can be located in different countries throughout the world, depending on the geographic coverage that is desired.

The system includes a Central Control Server 38 that receives sports related data from a variety of sources, such as from a real-time sports data server 37 coupled to the internet 36 or from an operator console 32. The embodiment shown in FIG. 6 also includes a mobile operator console 32c that communicates with the Central Control Server 38 via a wireless cell interface 39, to thereby provide real-time sports data and operator generated team event messages via a cell phone interface as shown.

In general, the Central Control Server receives real-time sports event data from these sources, analyzes the data to identify the occurrence of certain predefined events, and in response, instructs selected FM stations to broadcast team event messages via their FM broadcasts.

For each FM station, the system includes a server (the “Station Server”) 35 that couples the station to the Internet 36 (or other network) for receiving data that instructs the station to emit team event messages via that station's FM transmission, and for controlling the FM station's radio-data equipment 31 to implement these instructions.

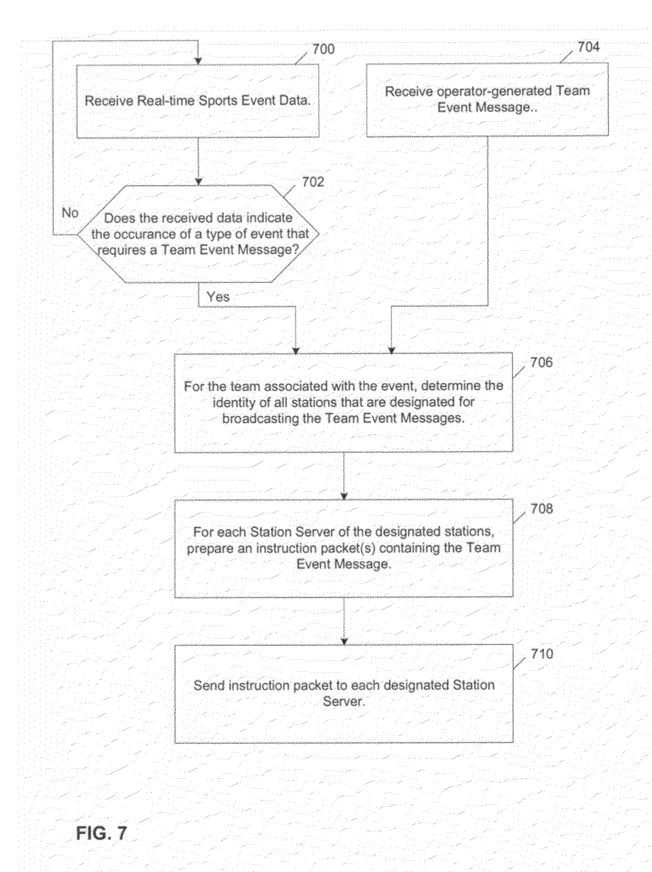

The general operation of the Central Control Server is depicted in FIG. 7. The server receives real-time sports data from any of a variety of sources (Step 700). In response, it analyzes the data to determine if a predetermined type of event has occurred (Step 702). These predefined events include particular types of events for which the Central Control Server will cause a team event message to be broadcast. For example, for a football team, events that could trigger a team event message might include a score by the team (e.g, touchdown, field goal etc.), a turnover in favor of the team, or a penalty call against the opposing team. For a baseball team, the events could include a home run, strike-out of an opposing player, or the victorious end to the game.

If the Central Control Server detects the occurrence of such a predefined event for a team, it sends a message to selected FM stations to cause them to broadcast a team event message as explained below (steps 706-710). Similarly, the Central Control Server will cause a team event messages to be broadcast if an operator manual requests one (Step 704).

Upon detection of such an event for a team, e.g., Team A, the Central Control Server determines the identity of all stations that are designated for broadcasting messages for Team A (Step 706). It prepares an instruction packet or packets for each such station and transmits the packet(s) to the station's server 35 via the Internet or other network (Steps 708-710).

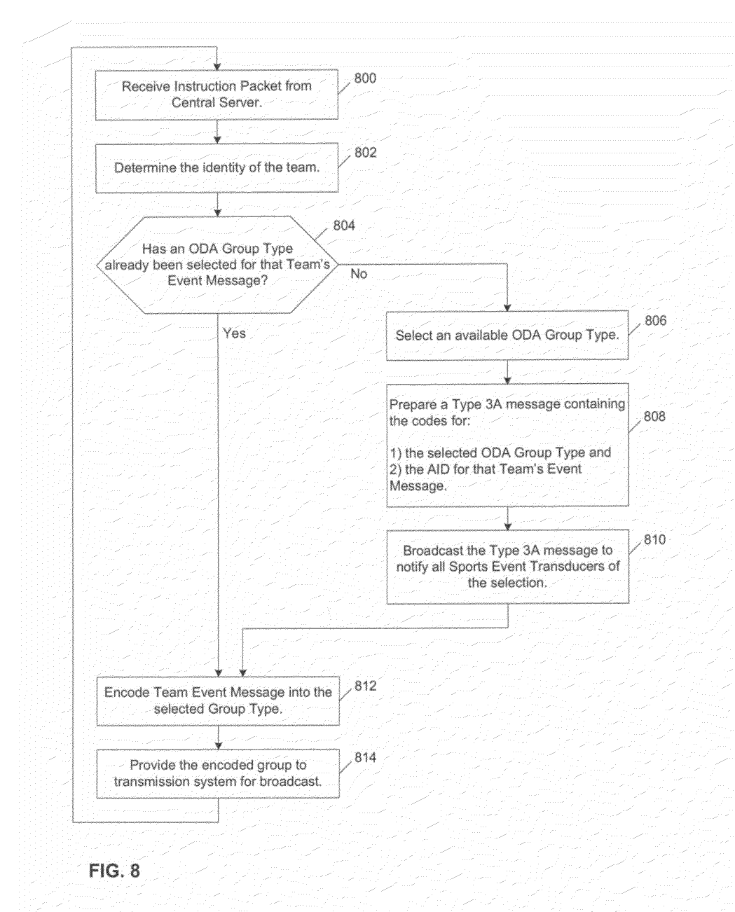

FIG. 8 depicts the operation of each Station Server 35 in response to the receipt of such a team event packet or packets. Upon receipt of such a packet (Step 800), the Station Server determines the identity of the team or teams to which the packet relates (Step 802). If an Open Data Application group type has already been selected for that team's event messages, the Station Server encodes data from the packet into a team event message using the selected group type (Step 812) and instructions the station's radio-data equipment 31 to broadcast the group as described above (step 814).

If an ODA group type has not been previously selected, the Station Server selects an available ODA group type for use in communicating with the sport event transducers (Step 806) and notifies all transducers of the selection by broadcasting a type 3A group as demonstrated in FIG. 4 (Step 808). The Station Server then encodes the team event message in the selected group type (as demonstrated in FIG. 5) and instructs the station's radio-data equipment 31 to broadcast the encoded message (Step 801).

Thus, each selected Station Server receives a packet containing instructions for forming a team event message and processes it in this manner. Thus the selected group of stations collectively broadcast the team event message over a wide area determined by the combined ranges of the selected FM stations.

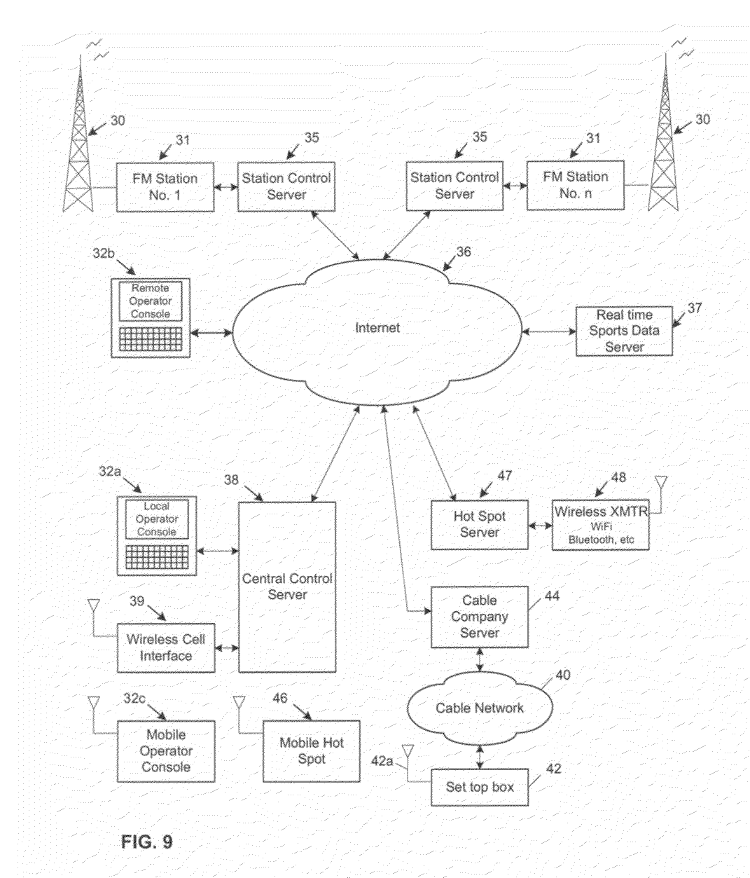

FIG. 9 depicts a system that includes other types of broadcast networks, such as one or more cable TV networks 40. In this embodiment, the cable company supplies its customers with cable TV decoder boxes 42 that include a local wireless transmitter 42(a) for emitting local wireless signals into the customer's home or business, such as for example in the WIFI or Bluetooth format. However, the cable boxes can use any wireless format that is compatible with the wireless receivers found in sports event transducers.

With this arrangement, the central control server 38 can send packets to a cable company server 44 via the internet, instructing the cable company server to broadcast team event messages via the wireless transmitters 42(a) of selected cable boxes 42. For example, if the packet contains a team event message that indicates that Team A has scored in a game, the cable company instructs all cable boxes 42 that are tuned to a televised broadcast of the game to transmit the team event message on their wireless transmitters. In this situation, there will likely be sports event transducers in the room where game is being televised, and any such sport event transducers will therefore receive the team event message and respond accordingly.

The transmission system of FIG. 9 can also transmit packets to selected hot spot wireless transmitters 48 that emit localized wireless signals that span a small region or “hot spot,” such as signals in the WIFI or Bluetooth formats. Each hot spot location includes a server 47 for receiving packets from the central control server 38 via the Internet. In response, the server 47 instructs a wireless transmitter 48 to emit a wireless signal embedded with the team event message. For example, a hot spot could be the home of a sports fan, a business location such as a sports bar, or a sports arena where a game is played.

The system of FIG. 9 also includes a mobile hot spot 46. Mobile device 46 includes a cell phone receiver for receiving a cell phone transmission from the central server 38. The mobile device also includes a local wireless transmitter for transmitting wireless signals such as those emitted by transmitters 42(a) and 48, but preferably in a very short-range wireless format such as Bluetooth. Thus, mobile device 46 receives from central server 38 a cell phone transmission instructing the device to emit a team event message. In response, the mobile device emits a team event message via its wireless transmitter for sports event transducers in close proximity to the device 46. In some embodiments, the mobile device 46 is itself a sports event transducer that responds directly to a team event message from central server 38.

The system can also include mechanisms for discouraging unauthorized Sport Event Transducers from responding to team event messages. For example, a station's control server 35 or the Central Control Server 38 can encrypt each team event message so that only devices with a proper cryptographic key can decipher the team event messages. Furthermore, these servers can occasionally emit decoy RDS groups that have the selected group type for a team event message, but whose data field 62 lacks a legitimate team event message, to thereby make it more difficult for unauthorized devices to know when legitimate team event messages are being issued.

The same architecture can be used to broadcast team event messages for all kinds of sporting events, wherein each Sport Event Transducer responds only to those broadcasts that relate to a particular team or player of interest. For example, the team identifiers can include a bit that indicates whether the team of interest is a local team (known only in the region of an FM transmitter, such as a little league team) or a more widely known team (such as an NFL team). This allows the system to efficiently distinguish between a very large number of teams throughout the country or world. Furthermore, in other embodiments, team event messages can be emitted for events other than sporting competitions. For example, during a parade, team event messages can be emitted to control garments worn by persons marching in the parade as well as persons watching the parade, to thereby generate an audio/visual demonstration.

While the invention has been described in conjunction with the above embodiments, numerous alternatives, modifications, variations and uses will be apparent to those skilled in the art.

What is claimed is:

1. A method for controlling a plurality of sport event transducers that each include a sport team identifier and a presentation element that emits a perceivable output in response to a team event message for the identified sport team, comprising:
determining when a predetermined team event has occurred that relates to said sport team,
in response to the occurrence of such a predetermined team event, encoding in real-time a team event message into an encoded output signal, wherein the team event message includes a team identifier code associated with said sport team, and
transmitting said encoded output signal to a plurality of sport event transducers.

2. The method of claim 1 further comprising the step of:
determining which of a plurality of commercial FM stations are designated to receive team event messages for said sport team, and
upon determining that a predetermined team event has occurred for the sport team, transmitting to said plurality of designated FM stations data instructing each of said stations to transmit said team event message in an FM radio-data signal.

3. The method of claim 1 wherein said encoding step encodes said team event message into an FM radio-data signal in accordance with the radio broadcast data standard, and wherein said transmitting step broadcasts said FM radio-data signal in a wide area RF broadcast.

4. The method of claim 3 further comprising the steps of:
selecting an open data application group type for use in transmitting team event messages,
preparing a type 3A group containing a registered application identifier for a sports event transducer application and containing the group type code of the selected open data application group type,
transmitting said type 3A group to notify a plurality of sport event transducers of the selected open data application group type.

5. The method of claim 4 wherein said encoding step comprises encoding said team event message in an RDS open data application group of the type chosen in the selecting step

6. The method of claim 1 wherein the step of determining when a predetermined team event has occurred comprises the steps of:
receiving real-time data relating to a competition involving said sport team, and
in response to said real time data, automatically determining when said predetermined team event has occurred.

7. A method for controlling a plurality of sport event transducers that each include a presentation element that emits a perceivable output in response to a team event message for a particular sport team, comprising:
selecting an open data application group from the radio-broadcast data standard for use in transmitting team event messages,
preparing a type 3A group containing a registered application identifier for a sports event transducer application and containing the group type code of the selected open data application,
transmitting said type 3A group to notify a plurality of sport event transducers of the selected open data application.
receiving real-time data relating to a competition involving the particular sport team, and
upon an occurrence of a team event, encoding in real-time a team event message into an encoded output signal, wherein said encoding step encodes said team event message into an FM radio-data signal using the selected open data application group type, and
transmitting said encoded output signal to a plurality of sport event transducers.

8. The claim 7 further comprising the step of:
determining which of a plurality of FM stations are designated to receive team event messages for a specified team, and
upon determining that a predetermined team event has occurred for the specified team, transmitting to said plurality of designated FM stations data instructing each of said stations to broadcast said team event message in an FM radio-data signal.
